(19) United States
(12) Patent Application Publication
(10) Pub. No.: US 2007/0002506 A1
(43) Pub. Date: Jan. 4, 2007

(54) Circuit protection system

(75) Inventors: Thomas F. Papallo, Farmington, CT (US); Marcelo E. Valdes, Burlington, CT (US)

Correspondence Address: Paul D. Greeley, Esq.;Ohlandt, Greeley, Ruggiero & Perle, L.L.P., One Landmark Square, 10th Floor, Stamford, CT, 06901-2682, US

(73) Assignee: General Electric Company

(21) Appl. No.: 11/171,118

(22) Filed: Jun. 30, 2005

(51) Int. Cl. H02H 7/04

(52) U.S. Cl. 361/38

(57) ABSTRACT

A circuit protection system is provided that provides simultaneous bus differential and transformer differential protection for a power distribution system. The circuit protection system can obviate the need for a circuit breaker disposed between the transformer and the power bus due to the un-delayed tripping of the upstream circuit breaker. The circuit protection system can also provide multiple layers of protection both upstream and downstream of the transformer and the power bus.

### BACKGROUND OF THE INVENTION

1. Field of the Invention

This disclosure relates generally to power distribution systems and more particularly, to a method and apparatus for a circuit protection system providing bus and transformer differential protection throughout the circuit.

2. Description of the Related Art

In power distribution systems, power is distributed to various loads and is typically divided into branch circuits, which supply power to specified loads. The branch circuits also can be connected to other power distribution equipment.

Due to the concern of an abnormal power condition in the system, i.e., a fault, it is known to provide circuit protective devices or power switching devices, e.g., circuit breakers, to protect the circuit. The circuit breakers seek to prevent or minimize damage and typically function automatically. The circuit breakers also seek to minimize the extent and duration of electrical service interruption in the event of a fault.

Bus differential protection and transformer differential protection are known protection schemes that are based upon the sum of the currents entering a node being equal to the sum of the currents leaving the node. Known bus and transformer differential protection requires dedicated devices, as well as sensing transformers for each circuit entering and exiting the node. Such protection schemes, especially for low voltage applications, are both costly and complex in configuration and size.

Accordingly, there is a need for circuit protection systems incorporated into power distribution systems that decrease the risk of damage and increase efficiency of the power distribution system. There is a further need for protection systems that achieve little or no delay in tripping upon occurrence of a fault without losing selectivity. There is yet a further need to achieve this at a minimum cost and size.

### BRIEF DESCRIPTION OF THE INVENTION

In one aspect, a method of protecting a circuit having a circuit breaker, a transformer and a power bus is provided which comprises: monitoring electrical parameters upstream and downstream of the transformer and the power bus; performing a protective function for the transformer and the power bus based on the electrical parameters; selectively generating a trip command based upon the protective function; and communicating the trip command to the circuit breaker thereby causing the circuit breaker to open.

In another aspect, a protection system for coupling to a circuit having a circuit breaker, a transformer and a power bus is provided. The system comprises a control-processing unit communicatively coupleable to the circuit so that the control-processing unit can monitor electrical parameters of the circuit upstream and downstream of the transformer and the power bus. The control-processing unit performs bus differential analysis and transformer differential analysis based on the electrical parameters. The control-processing unit selectively generates a trip command thereby opening the circuit breaker based upon the bus and transformer differential analysis.

In yet another aspect, a power distribution system is provided that comprises a circuit and a control-processing unit. The circuit has a transformer, a power bus and a circuit breaker. The control-processing unit is communicatively coupled to the circuit. The control-processing unit monitors electrical parameters of the circuit upstream and downstream of the transformer and the power bus. The control-processing unit performs bus differential analysis and transformer differential analysis based on the electrical parameters. The control-processing unit selectively generates a trip command thereby opening the circuit breaker based upon the bus and transformer differential analysis.

The above-described and other features and advantages of the present disclosure will be appreciated and understood by those skilled in the art from the following detailed description, drawings, and appended claims.

### BRIEF DESCRIPTION OF THE DRAWINGS

FIG. 1 is a schematic illustration of a power distribution system;

FIG. 2 is a schematic illustration of a module of the power distribution system of FIG. 1;

FIG. 3 is a response time for the protection system of FIG. 1;

FIG. 4 is a schematic illustration of a multiple source power distribution system;

FIG. 5 is a schematic illustration of one embodiment of a substation zone for a power distribution system;

FIG. 6 is a schematic illustration of another embodiment of a substation zone for a power distribution system; and

FIG. 7 is a schematic illustration of a preferred embodiment of a substation zone for a power distribution system.

### DETAILED DESCRIPTION OF THE INVENTION

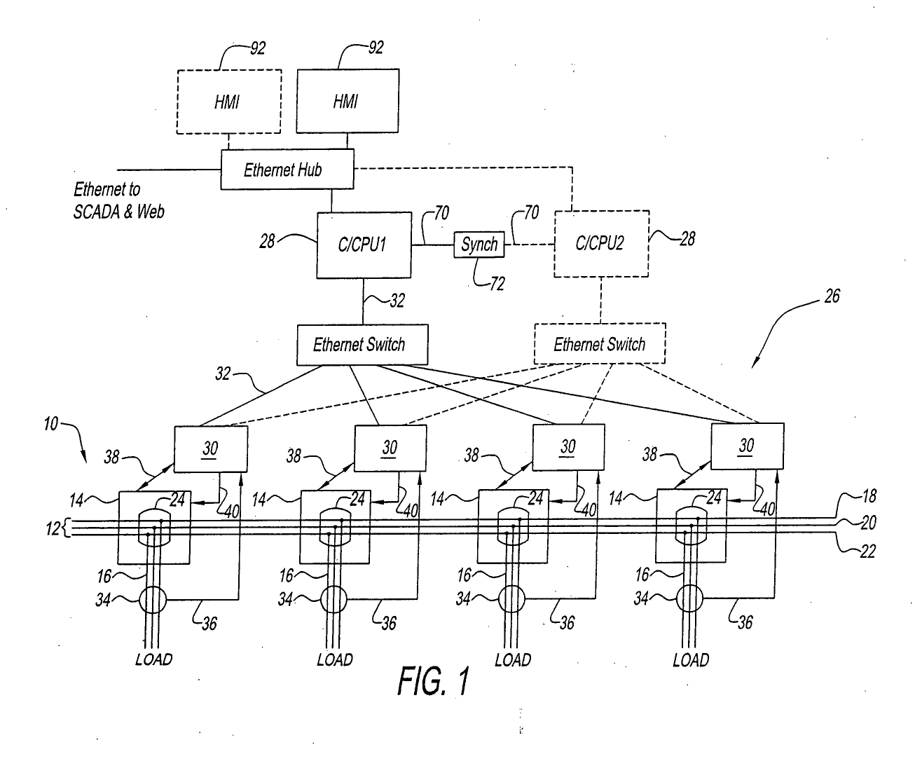

Referring now to the drawings and in particular to FIG. 1, an exemplary embodiment of a power distribution system generally referred to by reference numeral 10 is illustrated. System 10 distributes power from at least one power bus 12 through a number or plurality of power switching devices or circuit breakers 14 to branch circuits 16.

Power bus 12 is illustrated by way of example as a three-phase power system having a first phase 18, a second phase 20, and a third phase 22. Power bus 12 can also include a neutral phase (not shown). System 10 is illustrated for purposes of clarity distributing power from power bus 12 to four circuits 16 by four breakers 14. Of course, it is contemplated by the present disclosure for power bus 12 to have any desired number of phases and/or for system 10 to have any desired number of circuit breakers 14 and any topology of circuit breakers, e.g., in series, or in parallel, or other combinations.

Each circuit breaker 14 has a set of separable contacts 24 (illustrated schematically). Contacts 24 selectively place power bus 12 in communication with at least one load (also illustrated schematically) on circuit 16. The load can include devices, such as, but not limited to, motors, welding machinery, computers, heaters, lighting, and/or other electrical equipment.

Power distribution system 10 is illustrated in FIG. 1 with an exemplary embodiment of a centrally controlled and fully integrated protection, monitoring, and control system 26 (hereinafter “system”). System 26 is configured to control and monitor power distribution system 10 from a central control-processing unit 28 (hereinafter “CCPU”). CCPU 28 communicates with a number or plurality of data sample and transmission modules 30 (hereinafter “module”) over a data network 32. Network 32 communicates all of the information from all of the modules 30 substantially simultaneously to CCPU 28.

Thus, system 26 can include protection and control schemes that consider the value of electrical signals, such as current magnitude and phase, at one or all circuit breakers 14. Further, system 26 integrates the protection, control, and monitoring functions of the individual breakers 14 of power distribution system 10 in a single, centralized control processor (e.g., CCPU 28). System 26 provides CCPU 28 with all of a synchronized set of information available through digital communication with modules 30 and circuit breakers 14 on network 32 and provides the CCPU with the ability to operate these devices based on this complete set of data.

Specifically, CCPU 28 performs the primary power distribution functions for power distribution system 10. Namely, CCPU 28 may perform some or all of instantaneous over-current protection (IOC), short time over-current, longtime over-current, relay protection, and logic control as well as digital signal processing functions of system 26. Thus, system 26 enables settings to be changed and data to be logged in a single, central location, i.e., CCPU 28. CCPU 28 is described herein by way of example as a central processing unit. Of course, it is contemplated by the present disclosure for CCPU 28 to include any programmable circuit, such as, but not limited to, computers, processors, microcontrollers, microcomputers, programmable logic controllers, application specific integrated circuits, and other programmable circuits.

As shown in FIG. 1, each module 30 is in communication with one of the circuit breakers 14. Each module 30 is also in communication with at least one sensor 34 sensing a condition or electrical parameter of the power in each phase (e.g., first phase 18, second phase 20, third phase 22, and neutral) of bus 12 and/or circuit 16. Sensors 34 can include current transformers (CTs), potential transformers (PTs), and any combination thereof. Sensors 34 monitor a condition or electrical parameter of the incoming power in circuits 16 and provide a first or parameter signal 36 representative of the condition of the power to module 30. For example, sensors 34 can be current transformers that generate a secondary current proportional to the current in circuit 16 so that first signals 36 are the secondary current.

Module 30 sends and receives one or more second signals 38 to and/or from circuit breaker 14. Second signals 38 can be representative of one or more conditions of breaker 14, such as, but not limited to, a position or state of separable contacts 24, a spring charge switch status, a lockout state or condition, and others. In addition, module 30 is configured to operate or actuate circuit breaker 14 by sending one or more third signals 40 to the breaker to open/close separable contacts 24 as desired, such as open/close commands or signals. In a first embodiment, circuit breakers 14 cannot open separable contacts 24 unless instructed to do so by system 26.

System 26 utilizes data network 32 for data acquisition from modules 30 and data communication to the modules. Accordingly, network 32 is configured to provide a desired level of communication capacity and traffic management between CCPU 28 and modules 30. In an exemplary embodiment, network 32 can be configured to not enable communication between modules 30 (i.e., no module-to-module communication).

In addition, system 26 can be configured to provide a consistent fault response time. As used herein, the fault response time of system 26 is defined as the time between when a fault condition occurs and the time module 30 issues an trip command to its associated breaker 14. In an exemplary embodiment, system 26 has a fault response time that is less than a single cycle of the 60 Hz (hertz) waveform. For example, system 26 can have a maximum fault response time of about three milliseconds.

The configuration and operational protocols of network 32 are configured to provide the aforementioned communication capacity and response time. For example, network 32 can be an Ethernet network having a star topology as illustrated in FIG. 1. In this embodiment, network 32 is a full duplex network having the collision-detection multiple-access (CSMA/CD) protocols typically employed by Ethernet networks removed and/or disabled. Rather, network 32 is a switched Ethernet for preventing collisions.

In this configuration, network 32 provides a data transfer rate of at least about 100 Mbps (megabits per second). For example, the data transfer rate can be about 1 Gbps (gigabits per second). Additionally, communication between CCPU 28 and modules 30 across network 32 can be managed to optimize the use of network 32. For example, network 32 can be optimized by adjusting one or more of a message size, a message frequency, a message content, and/or a network speed.

Accordingly, network 32 provides for a response time that includes scheduled communications, a fixed message length, full-duplex operating mode, and a switch to prevent collisions so that all messages are moved to memory in CCPU 28 before the next set of messages is scheduled to arrive. Thus, system 26 can perform the desired control, monitoring, and protection functions in a central location and manner.

It should be recognized that data network 32 is described above by way of example only as an Ethernet network having a particular configuration, topography, and data transmission protocols. Of course, the present disclosure contemplates the use of any data transmission network that ensures the desired data capacity and consistent fault response time necessary to perform the desired range of functionality. The exemplary embodiment achieves sub-cycle transmission times between CCPU 28 and modules 30 and full sample data to perform all power distribution functions for multiple modules with the accuracy and speed associated with traditional devices.

CCPU 28 can perform branch circuit protection, zone protection, and relay protection interdependently because all of the system information is in one central location, namely at the CCPU. In addition, CCPU 28 can perform one or more monitoring functions on the centrally located system information. Accordingly, system 26 provides a coherent and integrated protection, control, and monitoring methodology not considered by prior systems. For example, system 26 integrates and coordinates load management, feed management, system monitoring, and other system protection functions in a low cost and easy to install system.

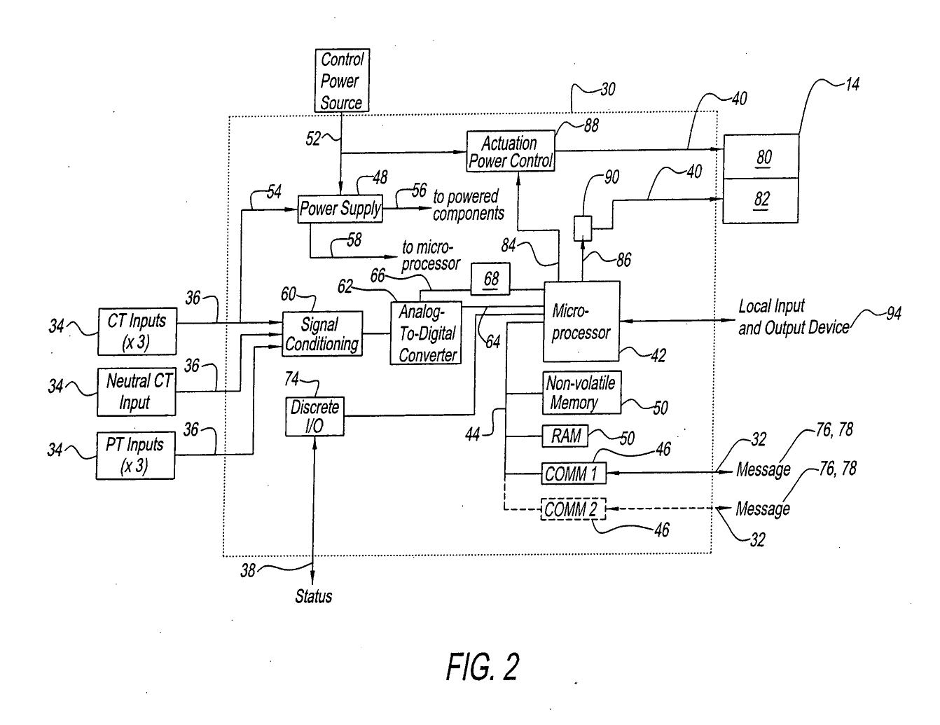

An exemplary embodiment of module 30 is illustrated in FIG. 2. Module 30 has a microprocessor 42, a data bus 44, a network interface 46, a power supply 48, and one or more memory devices 50.

Power supply 48 is configured to receive power from a first source 52 and/or a second source 54. First source 52 can be one or more of an uninterruptible power supply (not shown), a plurality of batteries (not shown), a power bus (not shown), and other sources. In the illustrated embodiment, second source 54 is the secondary current available from sensors 34.

Power supply 48 is configured to provide power 56 to module 30 from first and second sources 52, 54. For example, power supply 48 can provide power 56 to microprocessor 42, data bus 42, network interface 44, and memory devices 50. Power supply 48 is also configured to provide a fourth signal 58 to microprocessor 42. Fourth signal 58 is indicative of what sources are supplying power to power supply 48. For example, fourth signal 58 can indicate whether power supply 48 is receiving power from first source 52, second source 54, or both of the first and second sources.

Network interface 46 and memory devices 50 communicate with microprocessor 42 over data bus 44. Network interface 46 can be connected to network 32 so that microprocessor 42 is in communication with CCPU 28.

Microprocessor 42 receives digital representations of first signals 36 and second signals 38. First signals 36 are continuous analog data collected by sensors 34, while second signals 38 are discrete analog data from breaker 14. Thus, the data sent from modules 30 to CCPU 28 is a digital representation of the actual voltages, currents, and device status. For example, first signals 36 can be analog signals indicative of the current and/or voltage in circuit 16.

Accordingly, system 26 provides the actual raw parametric or discrete electrical data (i.e., first signals 36) and device physical status (i.e., second signal 38) to CCPU 28 via network 32, rather than processed summary information sampled, created, and stored by devices such as trip units, meters, or relays. As a result, CCPU 28 has complete, raw system-wide data with which to make decisions and can therefore operate any or all breakers 14 on network 32 based on information derived from as many modules 30 as the control and protection algorithms resident in CCPU 28 require.

Module 30 has a signal conditioner 60 and an analog-digital converter 62. First signals 36 are conditioned by signal conditioner 60 and converted to digital signals 64 by A/D converter 62. Thus, module 30 collects first signals 36 and presents digital signals 64, representative of the raw data in the first signals, to microprocessor 42. For example, signal conditioner 60 can include a filtering circuit (not shown) to improve a signal-to-noise ratio for first signal 36, a gain circuit (not shown) to amplify the first signal, a level adjustment circuit (not shown) to shift the first signal to a pre-determined range, an impedance match circuit (not shown) to facilitate transfer of the first signal to AID converter 62, and any combination thereof. Further, A/D converter 62 can be a sample-and-hold converter with external conversion start signal 66 from microprocessor 42 or a clock circuit 68 controlled by microprocessor 42 to facilitate synchronization of digital signals 64.

It is desired for digital signals 64 from all of the modules 30 in system 26 to be collected at substantially the same time. Specifically, it is desired for digital signals 64 from all of the modules 30 in system 26 to be representative of substantially the same time instance of the power in power distribution system 10.

Modules 30 sample digital signals 64 based, at least in part, upon a synchronization signal or instruction 70 as illustrated in FIG. 1. Synchronization instruction 70 can be generated from a synchronizing clock 72 that is internal or external to CCPU 28. Synchronization instruction 70 is simultaneously communicated from CCPU 28 to modules 30 over network 32. Synchronizing clock 72 sends synchronization instructions 70 at regular intervals to CCPU 28, which forwards the instructions to all modules 30 on network 32.

Modules 30 use synchronization instruction 70 to modify a resident sampling protocol. For example, each module 30 can have a synchronization algorithm resident on microprocessor 42. The synchronization algorithm resident on microprocessor 42 can be a software phase-lock-loop algorithm. The software phase-lock-loop algorithm adjusts the sample period of module 30 based, in part, on synchronization instructions 70 from CCPU 28. Thus, CCPU 28 and modules 30 work together in system 26 to ensure that the sampling (i.e., digital signals 64) from all of the modules in the system is synchronized.

Accordingly, system 26 is configured to collect digital signals 64 from modules 30 based in part on synchronization instruction 70 so that the digital signals are representative of the same time instance, such as being within a predetermined time-window from one another. Thus, CCPU 28 can have a set of accurate data representative of the state of each monitored location (e.g., modules 30) within the power distribution system 10. The predetermined time-window can be less than about ten microseconds. For example, the predetermined time-window can be about five microseconds.

The predetermined time-window of system 26 can be affected by the port-to port variability of network 32. In an exemplary embodiment, network 32 has a port-to-port variability of in a range of about 24 nanoseconds to about 720 nanoseconds. In an alternate exemplary embodiment, network 32 has a maximum port-to-port variability of about 2 microseconds.

It has been determined that control of all of modules 30 to this predetermined time-window by system 26 enables a desired level of accuracy in the metering and vector functions across the modules, system waveform capture with coordinated data, accurate event logs, and other features. In an exemplary embodiment, the desired level of accuracy is equal to the accuracy and speed of traditional devices. For example, the predetermined time-window of about ten microseconds provides an accuracy of about 99% in metering and vector finctions.

Second signals 38 from each circuit breaker 14 to each module 30 are indicative of one or more conditions of the circuit breaker. Second signals 38 are provided to a discrete I/O circuit 74 of module 30. Circuit 74 is in communication with circuit breaker 14 and microprocessor 42. Circuit 74 is configured to ensure that second signals 38 from circuit breaker 14 are provided to microprocessor 42 at a desired voltage and without jitter. For example, circuit 74 can include de-bounce circuitry and a plurality of comparators.

Microprocessor 42 samples first and second signals 36, 38 as synchronized by CCPU 28. Then, converter 62 converts the first and second signals 36, 38 to digital signals 64, which is packaged into a first message 76 having a desired configuration by microprocessor 42. First message 76 can include an indicator that indicates which synchronization signal 70 the first message was in response to. Thus, the indicator of which synchronization signal 70 first message 76 is responding to is returned to CCPU 28 for sample time identification.

CCPU 28 receives first message 76 from each of the modules 30 over network 32 and executes one or more protection and/or monitoring algorithms on the data sent in all of the first messages. Based on first message 76 from one or more modules 30, CCPU 28 can control the operation of one or more circuit breakers 14. For example, when CCPU 28 detects a fault from one or more of first messages 76, the CCPU sends a second message 78 to one or more modules 30 via network 32, such as open or close commands or signals, or circuit breaker actuation or de-actuation commands or signals.

In response to second message 78, microprocessor 42 causes third signal 40 to operate or actuate (e.g., open contacts 24) circuit breaker 14. Circuit breaker 14 can include more than one operation or actuation mechanism. For example, circuit breaker 14 can have a shunt trip 80 and a magnetically held solenoid 82. Microprocessor 42 is configured to send a first output 84 to operate shunt trip 80 and/or a second output 86 to operate solenoid 82. First output 84 instructs a power control module 88 to provide third signal 40 (i.e., power) to shunt trip 80, which can separate contacts 24. Second output 86 instructs a gating circuit 90 to provide third signal 40 to solenoid 82 (i.e., flux shifter) to separate contacts 24. It should be noted that shunt trip 80 requires first source 52 to be present, while solenoid 82 can be operated when only second source 54 is present. In this manner, microprocessor 42 can operate circuit breaker 14 in response to a specified condition, such as, for example, a detected over-current, regardless of the state of first and second sources 52, 54. Additionally, a lockout device can be provided that is operably connected to circuit breaker 14.

In addition to operating circuit breaker 14, module 30 can communicate to one or more local input and/or output devices 94. For example, local output device 94 can be a module status indicator, such as a visual or audible indicator. In one embodiment, device 94 is a light emitting diode (LED) configured to communicate a status of module 30. In another embodiment, local input device 94 can be a status-modifying button for manually operating one or more portions of module 30. In yet another embodiment, local input device 94 is a module interface for locally communicating with module 30.

Accordingly, modules 30 are adapted to sample first signals 36 from sensors 34 as synchronized by the CCPU. Modules 30 then package the digital representations (i.e., digital signals 64) of first and second signals 36, 38, as well as other information, as required into first message 76. First message 76 from all modules 30 are sent to CCPU 28 via network 32. CCPU 28 processes first message 76 and generates and stores instructions to control the operation of each circuit breaker 14 in second message 78. CCPU 28 sends second message 78 to all of the modules 30. In an exemplary embodiment, CCPU 28 sends second message 78 to all of the modules 30 in response to synchronization instruction 70.

Accordingly, system 26 can control each circuit breaker 14 based on the information from that breaker alone, or in combination with the information from one or more of the other breakers in the system 26. Under normal operating conditions, system 26 performs all monitoring, protection, and control decisions at CCPU 28.

Since the protection and monitoring algorithms of system 26 are resident in CCPU 28, these algorithms can be enabled without requiring hardware or software changes in circuit breaker 14 or module 30. For example, system 26 can include a data entry device 92, such as a human-machine-interface (HMI), in communication with CCPU 28. In this embodiment, one or more attributes and functions of the protection and monitoring algorithms resident on CCPU 28 can easily be modified from data entry device 92. Thus, circuit breaker 14 and module 30 can be more standardized than was possible with the circuit breakers/trip units of prior systems. For example, over one hundred separate circuit breakers/trip units have been needed to provide a full range of sizes normally required for protection of a power distribution system. However, the generic nature of circuit breaker 14 and module 30 enabled by system 26 can reduce this number by over sixty percent. Thus, system 26 can resolve the inventory issues, retrofittability issues, design delay issues, installation delay issues, and cost issues of prior power distribution systems.

It should be recognized that system 26 is described above as having one CCPU 28 communication with modules 30 by way of a single network 32. However, it is contemplated by the present disclosure for system 26 to have redundant CCPUs 26 and networks 32 as illustrated in phantom in FIG. 1. For example, module 30 is illustrated in FIG. 2 having two network interfaces 46. Each interface 46 is configured to operatively connect module 30 to a separate CCPU 28 via a separate data network 32. In this manner, system 26 would remain operative even in case of a failure in one of the redundant systems.

Modules 30 can further include one or more backup systems for controlling breakers 14 independent of CCPU 28. For example, system 26 may be unable to protect circuit 16 in case of a power outage in first source 52, during the initial startup of CCPU 28, in case of a failure of network 32, and other reasons. Under these failure conditions, each module 30 includes one or more backup systems to ensure that at least some protection is provided to circuit breaker 14. The backup system can include one or more of an analog circuit driven by second source 54, a separate microprocessor driven by second source 54, and others.

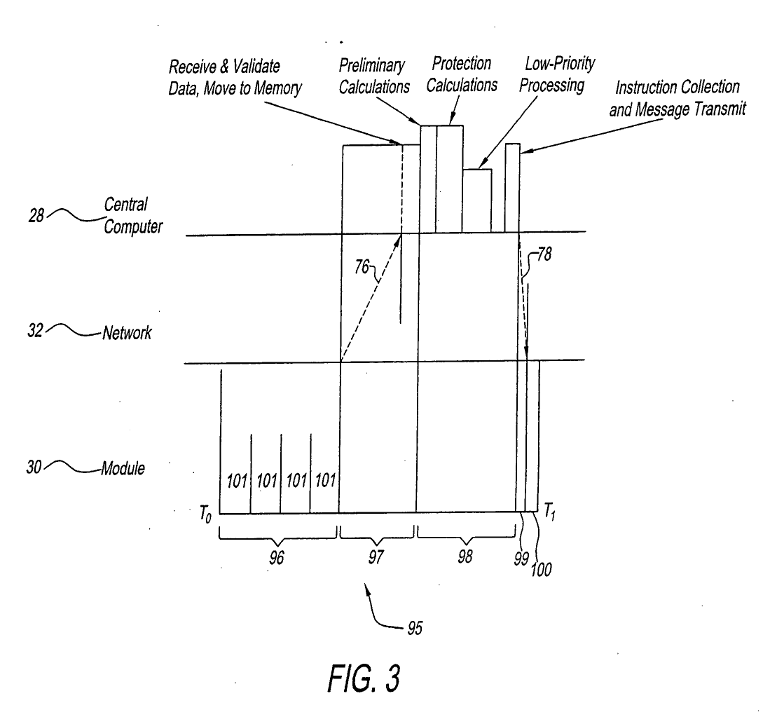

Referring now to FIG. 3, an exemplary embodiment of a response time 95 for system 26 is illustrated with the system operating stably (e.g., not functioning in a start-up mode). Response time 95 is shown starting at T0 and ending at T1. Response time 95 is the sum of a sample time 96, a receive/validate time 97, a process time 98, a transmit time 99, and a decode/execute time 100.

In this example, system 26 includes twenty-four modules 30 each connected to a different circuit breaker 14. Each module 30 is scheduled by the phase-lock-loop algorithm and synchronization instruction 70 to sample its first signals 36 at a prescribed rate of 128 samples per cycle. Sample time 96 includes four sample intervals 101 of about 0.13 milliseconds (ms) each. Thus, sample time 96 is about 0.27 ms for data sampling and packaging into first message 76.

Receive/validate time 97 can be initiated at a fixed time delay after the receipt of synchronization instruction 70. In an exemplary embodiment, receive/validate time 97 is a fixed time that is, for example, the time required to receive all first messages 76 as determined from the latency of data network 32. For example, receive/validate time 97 can be about 0.25 ms where each first message 76 has a size of about 1000 bits, system 26 includes twenty-four modules 30 (i.e., 24,000 bits), and network 32 is operating at about 100 Mbps. Accordingly, CCPU 28 manages the communications and moving of first messages 76 to the CCPU during receive/validate time 97.

The protection processes (i.e., process time 98) starts at the end of the fixed receive/validate time 97 regardless of the receipt of first messages 76. If any modules 30 are not sending first messages 76, CCPU 28 flags this error and performs all functions that have valid data. Since system 26 is responsible for protection and control of multiple modules 30, CCPU 28 is configured to not stop the entire system due to the loss of data (i.e., first message 76) from a single module 30. In an exemplary embodiment, process time 98 is about 0.52 ms.

CCPU 28 generates second message 78 during process time 98. Second message 78 can be twenty-four second messages (i.e., one per module 30) each having a size of about 64 bits per module. Alternately, it is contemplated by the present disclosure for second message 78 to be a single, multi-cast or broadcast message. In this embodiment, second message 78 includes instructions for each module 30 and has a size of about 1600 bits.

Transmit time 99 is the time necessary to transmit second message 78 across network 32. In the example where network 32 is operating at about 100 Mbps and second message 78 is about 1600 bits, transmit time 99 is about 0.016 ms.

It is also contemplated for second message 78 to include a portion of synchronization instruction 70. For example, CCPU 28 can be configured to send second message 78 upon receipt of the next synchronization instruction 70 from clock 72. In this example, the interval between consecutive second messages 76 can be measured by module 30 and the synchronization information in the second message, if any, can be used by the synchronization algorithm resident on microprocessor 42.

Once modules 30 receive second message 78, each module decodes the message and executes its instructions (i.e., send third signals 40), if any, in decode/execute time 100. For example, decode/execute time 100 can be about 0.05 ms.

In this example, response time 95 is about 1.11 ms. Of course, it should be recognized that system response time 95 can be accelerated or decelerated based upon the needs of system 26. For example, system response time 95 can be adjusted by changing one or more of the sample period, the number of samples per transmission, the number of modules 30, the message size, the message frequency, the message content, and/or the network speed.

It is contemplated by the present disclosure for system 26 to have response time 95 of up to about 3 milliseconds. Thus, system 26 is configured to open any of its circuit breakers within about 3 milliseconds from the time sensors 34 sense conditions outside of the set parameters.

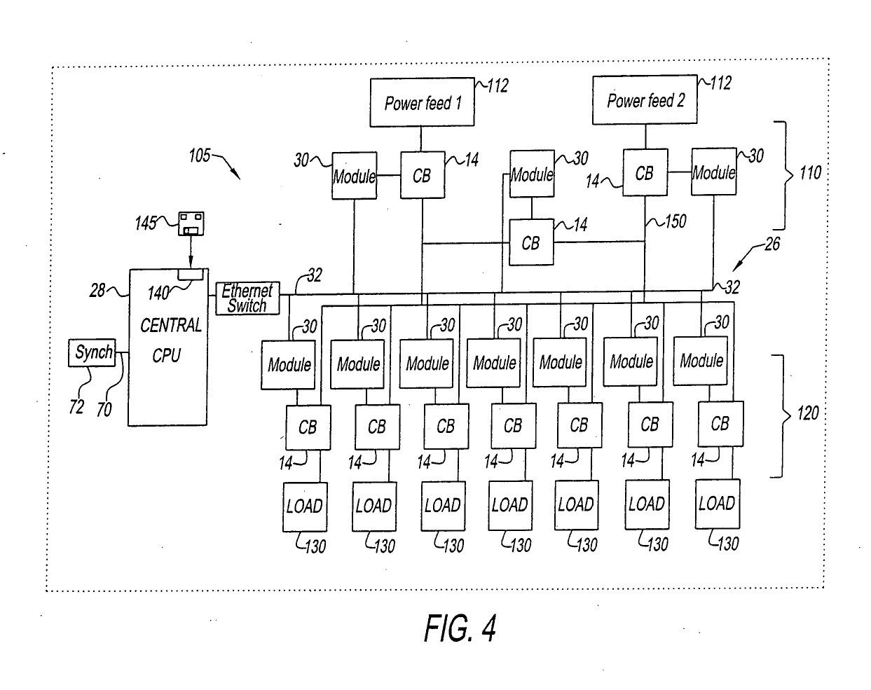

Referring to FIG. 4, an exemplary embodiment of a multi-source, multi-tier power distribution system generally referred to by reference numeral 105 is illustrated with features similar to the features of FIG. 1 being referred to by the same reference numerals. System 105 functions as described above with respect to the embodiment of FIGS. 1 through 3, and can include the same features but in a multi-source, multi-layer configuration. System 105 distributes power from at least one power feed 112, in this embodiment a first and second power feed, through a power distribution bus 150 to a number or plurality of circuit breakers 14 and to a number or plurality of loads 130. CCPU 28 can include a data transmission device 140, such as, for example, a CD-ROM drive or floppy disk drive, for reading data or instructions from a medium 145, such as, for example, a CD-ROM or floppy disk.

Circuit breakers 14 are arranged in a layered, multi-leveled or multi-tiered configuration with a first level 110 of circuit breakers and a second level 120 of circuit breakers. Of course, any number of levels or configuration of circuit breakers 14 can be used with system 105. The layered configuration of circuit breakers 14 provides for circuit breakers in first level 110 which are upstream of circuit breakers in second level 120. In the event of an abnormal condition of power in system 105, i.e., a fault, protection system 26 seeks to coordinate the system by attempting to clear the fault with the nearest circuit breaker 14 upstream of the fault. Circuit breakers 14 upstream of the nearest circuit breaker to the fault remain closed unless the downstream circuit breaker is unable to clear the fault. Protection system 26 can be implemented for any abnormal condition or parameter of power in system 105, such as, for example, long time, short time or instantaneous over-currents, or excessive ground currents.

In order to provide the circuit breaker 14 nearest the fault with sufficient time to attempt to clear the fault before the upstream circuit breaker is opened, the upstream circuit breaker is provided with an open command at an adjusted or dynamic delay time. The upstream circuit breaker 14 is provided with an open command at a modified dynamic delay time that elapses before the circuit breaker is opened. In an exemplary embodiment, the modified dynamic delay time for the opening of the upstream circuit breaker 14 is based upon the location of the fault in system 105. The modified dynamic delay time for the opening of the upstream circuit breaker 14 can be based upon the location of the fault with respect to the circuit breakers and/or other devices and topology of system 105.

CCPU 28 of protection system 26 can provide open commands at modified dynamic delay times for upstream circuit breakers 14 throughout power distribution system 105 depending upon where the fault has been detected in the power flow hierarchy and the modified dynamic delay times for the opening of each of these circuit breakers can be over an infinite range. Protection system 26 reduces the clearing time of faults because CCPU 28 provides open commands at modified dynamic delay times for the upstream circuit breakers 14 which are optimum time periods based upon the location of the fault. It has been found that the clearing time of faults has been reduced by approximately 50% with the use of protection system 26, as compared to the use of contemporary systems.

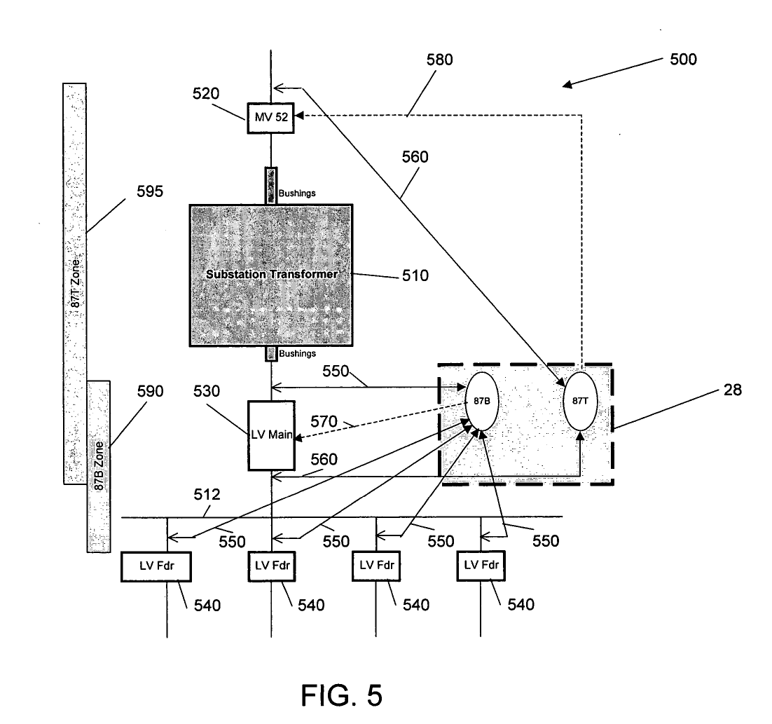

Referring to FIG. 5, an exemplary embodiment of a portion of a power distribution system, i.e., a substation zone, is shown and generally represented by reference numeral 500. Substation zone 500 has a substation transformer 510 and a power bus 512. Substation zone 500 is a portion of a power distribution system, similar to power distribution systems 10 and 105 described above with respect to FIGS. 1 through 3 and 4, respectively, and has similar features although not all are shown. The power distribution system can have a number of substation zones similar to substation zone 500, which are in various configurations throughout the system.

Substation zone 500 has a circuit breaker 520 upstream of the substation transformer 510. In this exemplary embodiment, circuit breaker 520 is a medium voltage circuit breaker. Substation zone 500 also has a main circuit breaker 530, which is downstream of the substation transformer 510 and upstream of the power bus 512. A number of feeder circuits having feeder circuit breakers 540 are located downstream of the main circuit breaker 530 and the power bus 512. In this exemplary embodiment, main circuit breaker 530 is a low voltage circuit breaker. While the feeder circuit breakers 540 are shown connected in parallel, the present disclosure contemplates alternative topologies for the substation zone 500 and alternative configurations, connections and/or topology for the feeder circuit breakers, such as, for example, connected in series and/or combinations of parallel and series configurations.

Substation zone 500 is operably connected to the protection, monitoring and control system 26 described above with respect to power distribution systems 10 and 105. While FIG. 5 shows only the CCPU 28 from the system 26 for clarity, substation zone 500 and the protection system 26 has other features described above with respect to power distribution systems 10 and 105 including, but not limited to, modules, a network and sensors.

CCPU 28 provides for bus differential analysis and protection of substation zone 500 through the use of a bus protection scheme 87B. Similarly, CCPU 28 provides for transformer differential analysis and protection of substation zone 500 through the use of a transformer protection scheme 87T. Bus and transformer protection schemes 87B and 87T are algorithms and the like that analyze the parameters of substation zone 500 and determine if implementation of protection, e.g., tripping of a circuit breaker, is warranted.

Bus protection signals 550 are provided to CCPU 28 and bus protection scheme 87B for analysis. The data or information which is represented by signals 550 is collected and the signals are communicated as described above with respect to system 26 of power distribution systems 10 and 105, and can be done so through the use of sensors, modules, a network and the signals and messages communicated therebetween (as shown in FIGS. 1, 2 and 4). The bus protection signals 550 provide information to the CCPU 28, e.g., data representative of the current, both upstream and downstream of the power bus 512. In an exemplary embodiment, the bus protection signals 550 have data for secondary currents generated by current transformers (not shown), where each of the secondary currents is proportional to the current at selected points upstream and downstream of the power bus 512. The current transformers can be part of the sensors of the protection system 26 that are operably connected to points along substation zone 500. However, the present disclosure contemplates communication to CCPU 28 of various information and data representative of the parameters of substation zone 500, only a portion of which would be the secondary current for each of the selected points.

Transformer protection signals 560 are provided to CCPU 28 and transformer protection scheme 87T for analysis. The data or information represented by signals 560 is also collected and the signals communicated by system 26 as described above with respect to power distribution systems 10 and 105, and can be done so through the use of the sensors, modules, network and the signals and messages communicated therebetween. The transformer protection signals 560 provide information to the CCPU 28, e.g., data representative of the current, both upstream and downstream of the substation transformer 510. In an exemplary embodiment, the transformer protection signals 560 have data for secondary currents generated by current transformers (not shown), where each of the secondary currents is proportional to the current at selected points upstream and downstream of the substation transformer 510. These current transformers can also be a part of the sensors of the protection system 26 that are operably connected to points along substation zone 500. Although, the present disclosure contemplates communication to CCPU 28 of various information and data representative of the parameters of substation zone 500, only a portion of which would be the secondary current for each of the selected points. System 26 provides synchronized, real time, per sample data via the network from multiple points of the substation zone 500 and throughout the power distribution system to

Based upon the data or information provided by bus protection signals 550 and transformer protection signals 560, the bus and transformer protection schemes 87B and 87T can determine the existence and location of a fault in substation zone 500. CCPU 28 can communicate a command or signal 570 to trip the low voltage main circuit breaker 530 or the CCPU can communicate a command or signal 580 to trip the medium voltage circuit breaker 520 depending upon the location of the fault. The protection system 26 provides for an 87B zone or layer of protection generally represented by reference numeral 590 and an 87T zone or layer of protection generally represented by reference numeral 595. Zones 590 and 595 are situated to provide for protection of both the substation transformer 510 and the power bus 512 upstream and downstream of those devices. System 26 provides for simultaneous bus protection and transformer protection to substation zone 500.

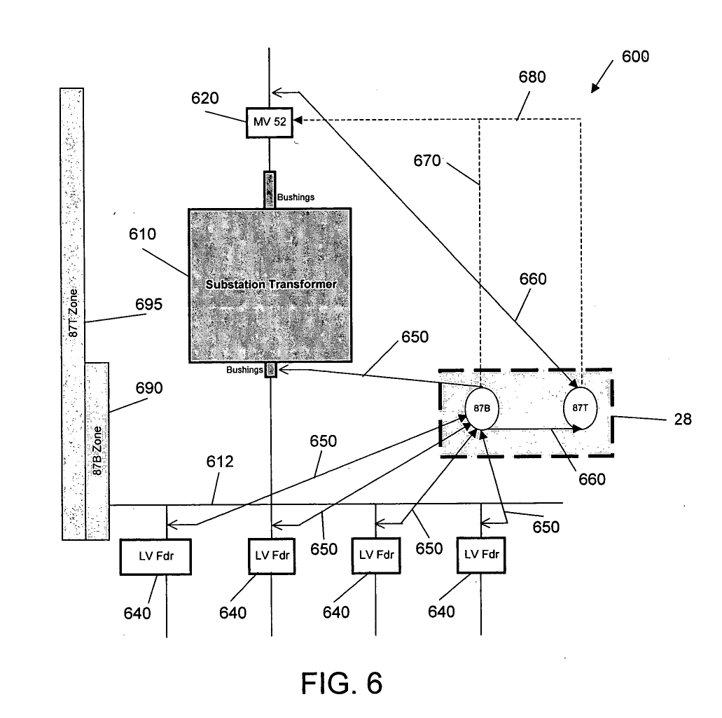

Referring to FIG. 6, a second exemplary embodiment of a substation zone is shown and generally represented by reference numeral 600. Substation zone 600 has a substation transformer 610 and a power bus 612. Substation zone 600 is a portion of a power distribution system, similar to power distribution systems 10 and 105 described above with respect to FIGS. 1 through 3 and 4, respectively, and has similar features although not all are shown. The power distribution system can have a number of substation zones similar to substation zone 600, which are in various configurations through the system.

Similar to substation zone 500 described above, zone 600 has a circuit breaker 620 upstream of the substation transformer 610, which can be a medium voltage circuit breaker. However, substation zone 600 does not require an additional circuit breaker disposed downstream of the substation transformer 610 and upstream of the power bus 612, i.e., a low voltage main circuit breaker. A number of feeder circuits having feeder circuit breakers 640 are located downstream of the power bus 612. While the feeder circuit breakers 640 are shown connected in parallel, the present disclosure contemplates alternative topology for the substation zone 600 and alternative configurations, connections and/or topology for the feeder circuit breakers, such as, for example, connected in series and combinations of parallel and series connections. Substation zone 600 is operably connected to the protection, monitoring and control system 26 described above with respect to power distribution systems 10 and 105, although only the CCPU 28 is shown for clarity. The substation zone 600 and the protection system 26 include, but are not limited to, modules, a network and sensors (shown in FIGS. 1, 2 and 4).

Similar to the protection provided by CCPU 28 with respect to substation zone 500, the CCPU performs bus and transformer differential analysis and protection for substation zone 600 through the use of a bus protection scheme 87B and a transformer protection scheme 87T, respectively. The bus and transformer protection schemes 87B and 87T are algorithms and the like that analyze the parameters of substation zone 600. Based upon these parameters, CCPU 28, through use of schemes 87B and 87T, determines if implementation of protection, e.g., tripping of a circuit breaker, is warranted.

System 26 uses bus protection signals 650 and transformer protection signals 660 that are provided to CCPU 28 for analysis by bus protection scheme 87B and transformer protection scheme 87T, respectively. The data or information represented by signals 650 and 660 is collected and the signals are communicated as described-above with respect to system 26 of power distribution systems 10 and 105, and can be done so through the use of the sensors, modules, and network, and the signals and messages communicated therebetween (as shown in FIGS. 1, 2 and 4). The signals 650 provide information or data to the CCPU 28 that is representative of the current, both upstream and downstream of the power bus 612, while the signals 660 provide information or data to the CCPU that is representative of the current, both upstream and downstream of the substation transformer 610. In the exemplary embodiment of substation zone 600 of FIG. 6, one of the transformer protection signals 660 is shown being communicated from bus protection scheme 87B to transformer protection scheme 87T. System 26 provides synchronized, real time, per sample data from multiple points within substation zone 600 to CCPU 28 and thus the same data may be used in multiple functions by the CCPU.

In an exemplary embodiment, the bus protection signals 650 have data for secondary currents generated by current transformers (not shown), where each of the secondary currents is proportional to the current at selected points upstream and downstream of the power bus 612, and the transformer protection signals 660 have data for secondary currents generated by current transformers (not shown), where each of those secondary currents is proportional to the current at selected points upstream and downstream of the substation transformer 610. The current transformers can be part of the sensors of the protection system 26 that are operably connected to points along substation zone 600. The present disclosure contemplates communication to CCPU 28 of various information and data representative of the parameters of substation zone 600, only a portion of which would be the secondary currents for the selected points.

Based upon the data or information provided by bus protection signals 650 and transformer protection signals 660, the bus and transformer protection schemes 87B and 87T can determine the existence and location of a fault in substation zone 600. CCPU 28 can communicate a command or signal 670 to trip the circuit breaker 620 depending upon the existence and location of the fault as determined by bus protection scheme 87B, and the CCPU can communicate a command or signal 680 to trip the circuit breaker 620 depending upon the existence and location of the fault as determined by transformer protection scheme 87T. The protection system 26 provides for an 87B zone or layer of protection generally represented by reference numeral 690 and an 87T zone or layer of protection generally represented by reference numeral 695. Zones 690 and 695 are situated to provide for protection of both the substation transformer 610 and the power bus 612 upstream and downstream of those devices.

Unlike the substation zone 500, system 26 communicates the bus protection command 670 to the medium voltage circuit breaker 620, which is upstream of the substation transformer 610. This obviates the requirement of a low voltage circuit breaker between the substation transformer 610 and the power bus 612, which provides an advantage in both reducing cost and complexity of the substation zone 600 and the overall power distribution system to which the substation zone is connected. The use of system 26 coupled to substation zone 600 provides for un-delayed tripping of the medium voltage circuit breaker 620 upon the occurrence of a fault in the substation zone, while still minimizing energy delivered to the fault and maintaining the selectivity for the overall power distribution system to which substation zone 600 is connected. The bus and transformer protection schemes 87B and 87T can use devices and/or data that are being utilized by other protective functions of system 26. System 26 provides for simultaneous bus protection and transformer protection to substation zone 600.

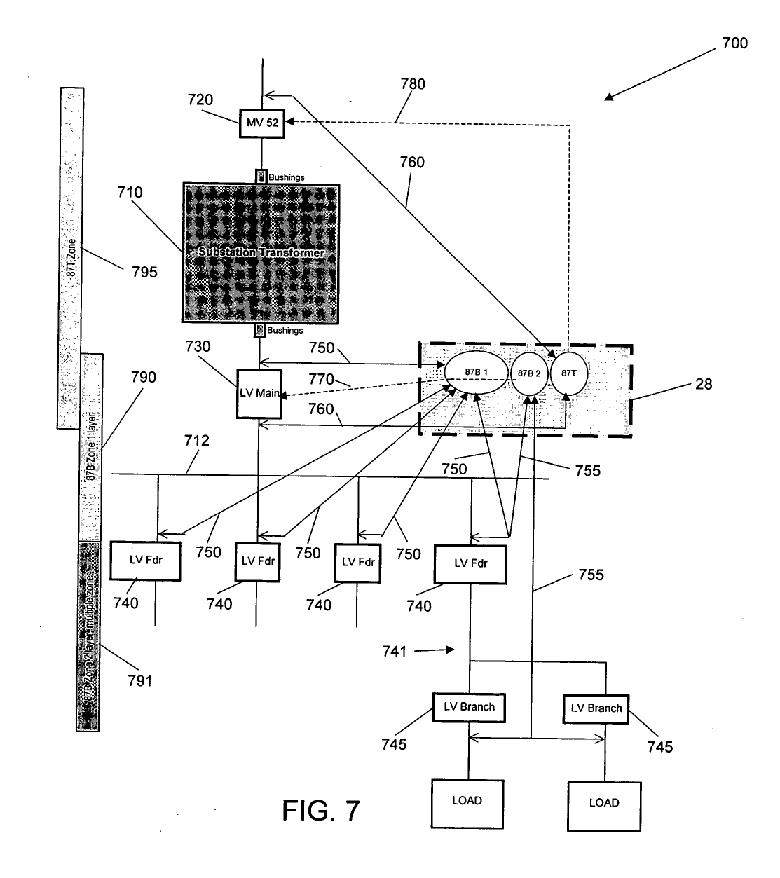

Referring to FIG. 7, a third, and preferred, exemplary embodiment of a substation zone is shown and generally represented by reference numeral 700. Substation zone 700 has a substation transformer 710 and a power bus 712. Similar to substation zones 500 and 600, the substation zone 700 is a portion of a power distribution system, which is similar to power distribution systems 10 and 105, and has similar features, such as, for example, modules, a network and sensors, although not shown. The power distribution system can have a number of substation zones similar to substation zone 700, which are in various configurations.

Substation zone 700 has a medium voltage circuit breaker 720 upstream of the substation transformer 710 and a low voltage main circuit breaker 730 disposed between the substation transformer and the power bus 712. A number of feeder circuits having feeder circuit breakers 740 are located downstream of the power bus 712. While the feeder circuit breakers 740 are shown connected in parallel, the present disclosure contemplates alternative topologies for the feeder circuits and alternative configurations, branches and connections for the feeder circuit breakers, such as, for example, connected in series and combinations of parallel and series configurations. Substation zone 700 has a branch circuit 741 further downstream of the power bus 712, which has a number of branch circuit breakers 745. In the exemplary embodiment of FIG. 7, branch circuit 741 is connected to one of the feeder circuit breakers 740 and has two branch circuit breakers 745 connected in parallel with each other. However, the present disclosure contemplates different numbers and configurations for the branch circuit 741, which can be connected to one or more of the feeder circuit breakers 740. Substation zone 700 is operably connected to the protection, monitoring and control system 26 described above with respect to power distribution systems 10 and 105, and has features of the system including, but not limited to, the modules, network and the sensors shown in FIGS. 1, 2 and 4.

Similar to the protection provided by CCPU 28 with respect to substation zone 500 of FIG. 5, the CCPU performs bus and transformer differential analysis and protection of substation zone 700 through the use of bus protection schemes 87B 1 and 87B2 and transformer protection scheme 87T, respectively. The bus and transformer protection schemes 87B13, 87B2 and 87T are algorithms and the like that analyze the parameters of substation zone 700 and determine if implementation of protection, e.g., tripping of a circuit breaker, is warranted.

However, unlike substation zone 500, the substation zone 700 provides for multiple layers of bus differential protection. Bus protection signals 750 and 755 are provided to CCPU 28 and bus protection schemes 87B11 and 87B2 for analysis. The data or information represented by signals 750 and 755 is collected and the signals are communicated as described-above with respect to system 26 of power distribution systems 10 and 105, and can be done so through the use of the sensors, modules, and network, and the signals and messages communicated therebetween. The bus protection signals 750 and 755 provide information or data to the CCPU 28 representative of the current that is upstream and downstream of the power bus 712 and the current that is upstream and downstream of the branch circuit 741, respectively. In an exemplary embodiment, the bus protection signals 750 and 755 have data for secondary currents generated by current transformers (not shown), where each of the secondary currents is proportional to the current at selected points upstream and downstream of the power bus 712 and the branch circuit 741. However, the present disclosure contemplates communication to CCPU 28 of various information and data representative of the parameters of substation zone 700, only a portion of which would be the secondary currents for the selected points. The current transformers can be part of the sensors of the protection system 26 that are operably connected to points along substation zone 700.

Transformer protection signals 760 are provided to CCPU 28 and transformer protection scheme 87T for analysis, and the data or information represented by the signals is collected and the signals are communicated as described-above with respect to system 26 of power distribution systems 10 and 105, and can be done so through the use of the sensors, modules, and network, and the signals and messages communicated therebetween. The transformer protection signals 760 provide data and information representative of the current that is upstream and downstream of the substation transformer 710. In an exemplary embodiment, the transformer protection signals 760 have data for secondary currents generated by current transformers (not shown), where each of the secondary current is proportional to the current at selected points upstream and downstream of the substation transformer 710. The current transformers can be part of the sensors of the protection system 26 that are operably connected to points along substation zone 700. However, the present disclosure contemplates communication to CCPU 28 of various information and data representative of the parameters of substation zone 700, only a portion of which would be the secondary currents for the selected points.

Based upon the data or information provided by bus protection signals 750 and 755 and transformer protection signals 760, the bus and transformer protection schemes 87B1, 87B2 and 87T can determine the existence and location of a fault in substation zone 700. CCPU 28 can communicate a command or signal 770 to trip the low voltage main circuit breaker 730 or the CCPU can communicate a command or signal 780 to trip the medium voltage circuit breaker 720 depending upon the existence and location of the fault. The protection system 26 provides for a pair of 87B zones or layers of protection generally represented by reference numerals 790 and 791, respectively, and an 87T zone or layer of protection generally represented by reference numeral 795. System 26 provides for simultaneous bus protection and transformer protection to substation zone 700.

Substation zone 700 extends the zone of protection at least one layer upstream and at least one layer downstream of the power bus 712. The present disclosure contemplates extending the zone of protection by any number of layers both upstream and downstream of the power bus 712, the substation 710 or any other selected device or point along the power distribution system. The downstream zone of protection, i.e., the 87B2 layer of protection 791, can be limited to the load side of larger feeder circuits, such as, for example, feeding 800 amp to 1600 amp circuit breakers. However, the present disclosure contemplates the use of one or more downstream zones or layers of protection for any size or capacity of circuit, even smaller feeder circuits. For smaller feeder circuits, such as, for example, feeding 600 amp circuit breakers, metering rather than control by system 26 can be utilized.

Due to the use of system 26 as described above, the feeder circuit breaker 740 that is directly upstream of the branch circuit 741 does not require instantaneous trip capability. Alternatively, the instantaneous tripping or fault value of the feeder circuit breaker 740 that is directly upstream of the branch circuit 741 can be set high. The lower fault values will be detected by the 87B2 zone of protection 791. This maintains the selectivity for the substation zone 700, while still minimizing the risk of damage due to the use of the multiple layer bus protection schemes 87B1 and 87B2. Where the instantaneous tripping value is set high, the value can be up to 85% of the SC rating of the circuit breaker and can be adjustable.

The branch circuit breakers 745 can operate based upon the instantaneous trip function alone. This obviates the need for internal sensors, bimetal devices, intentional sources of heat or other wasted energy. As described above with respect to power distribution systems 10 and 105, system 26 can perform other protective functions within the substation zone 700 including along branch circuit 741 such as, for example, short time over-current, longtime over-current and ground fault functions to complement the protection described above. The branch circuit breakers 745 can be set to trip only on high magnitude faults as determined by system 26, which maintains the selectivity for the power distribution system.

Alternatively, the branch circuit breakers 745 can operate based on typical tripping functions. System 26 would then provide metering and/or control to those circuit breakers upstream of the branch circuit breakers 745, e.g., feeder circuit breakers 740, low voltage main circuit breaker 730 and medium voltage circuit breaker 720.

The system allows for metering and/or control of the circuit breakers. Control of the starter and starter circuit protection could be done by a local EOL or a control node. The node would provide local processing for starter protection and communication to into a process control network. Advanced metering can also be done based on raw data supplied by the node.

The embodiments of FIGS. 1 through 7 describe the implementation of protection schemes, algorithms, routines and the like at CCPU 28. However, it is contemplated by the present disclosure that the use of such schemes, algorithms, routines and the like can be implemented in other ways such as, for example, in a distributed control system with supervision by CCPU 28 or a distributed control system with peer to peer communications.

The protection provided by protection system 26 is based in part upon current and/or voltage calculations from multiple circuit points that are power sources or power sinks, and connected in parallel or in series. The state or topology of the system is recognized and effectively evaluated at the same speed as the current and/or voltage calculations.

While the instant disclosure has been described with reference to one or more exemplary embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this invention, but that the invention will include all embodiments falling within the scope of the appended claims.

What is claimed is:

1. A method of protecting a circuit having a circuit breaker, a transformer and a power bus comprising:
monitoring electrical parameters upstream and downstream of the transformer and the power bus;
performing a protective function for the transformer and the power bus based on said electrical parameters;
selectively generating a trip command based upon said protective function; and
communicating said trip command to the circuit breaker thereby causing the circuit breaker to open.

2. The method of claim 1, wherein said protective function is bus differential and transformer differential functions, and wherein said electrical parameters are currents at selected points upstream and downstream of the transformer and the power bus.

3. The method of claim 1, further comprising communicating signals representative of said electrical parameters over a network to a microprocessor.

4. The method of claim 3, wherein said protective function is performed by said microprocessor, wherein said trip command is generated by said microprocessor, and wherein said trip command is communicated to the circuit breaker over said network.

5. The method of claim 1, further comprising:
sensing said electrical parameters with a sensor;
communicating signals representative of said electrical parameters to a module; and
communicating said signals to a microprocessor, wherein said module, said sensor and said microprocessor are communicatively coupled.

6. The method of claim 1, wherein opening the circuit breaker prevents flow of energy to both the transformer and the power bus.

7. The method of claim 1, wherein the circuit breaker is a first circuit breaker and a second circuit breaker, the first circuit breaker being disposed between the transformer and the power bus, the second circuit breaker being disposed upstream of the transformer, wherein said protective function is bus differential and transformer differential f unctions, wherein said trip command generated based upon said bus differential function causes the first circuit breaker to open, and wherein said trip command generated based upon said transformer differential function causes the second circuit breaker to open.

8. A protection system for coupling to a circuit having a circuit breaker, a transformer and a power bus, the system comprising:
a control-processing unit being communicatively coupleable to the circuit, so that said control-processing unit can monitor electrical parameters of the circuit upstream and downstream of the transformer and the power bus, wherein said control-processing unit performs bus differential analysis and transformer differential analysis based on said electrical parameters, and wherein said control-processing unit selectively generates a trip command thereby opening the circuit breaker based upon said bus and transformer differential analysis.

9. The system of claim 8, further comprising a plurality of current transformers operably connected to the circuit, wherein said electrical parameters are secondary currents generated at selected points upstream and downstream of the transformer and the power bus by said plurality of current transformers.

10. The system of claim 8, further comprising a network in communication with said control-processing unit and the circuit.

11. The system of claim 10, further comprising a module and a sensor, said module being in communication with the circuit breaker, said sensor and said control-processing unit, wherein said sensor senses said electrical parameters and communicates a signal representative of said electrical parameters to said module, and wherein said module communicates said signal to said control-processing unit.

12. A power distribution system comprising:
a circuit having a transformer, a power bus and a circuit breaker; and
a control-processing unit communicatively coupled to said circuit, wherein said control-processing unit monitors electrical parameters of said circuit upstream and downstream of said transformer and said power bus, wherein said control-processing unit performs bus differential analysis and transformer differential analysis based on said electrical parameters, and wherein said control-processing unit selectively generates a trip command thereby opening said circuit breaker based upon said bus and transformer differential analysis.

13. The system of claim 12, further comprising a plurality of current transformers operably connected to said circuit, wherein said electrical parameters are secondary currents generated at selected points upstream and downstream of said transformer and said power bus by said plurality of current transformers.

14. The system of claim 12, further comprising a network in communication with said control-processing unit and said circuit.

15. The system of claim 14, further comprising a module and a sensor, said module being in communication with said circuit breaker, said sensor and said control-processing unit, wherein said sensor senses said electrical parameters and communicates a signal representative of said electrical parameters to said module, and wherein said module communicates said signal to said control-processing unit.

16. The system of claim 12, wherein said circuit breaker is upstream of said transformer and said power bus.

17. The system of claim 12, wherein said circuit breaker is a first circuit breaker and a second circuit breaker, said first circuit breaker being disposed between said transformer and said power bus, said second circuit breaker being disposed upstream of said transformer, wherein said trip command generated based upon said bus differential analysis causes said first circuit breaker to open, and wherein said trip command generated based upon said transformer differential analysis causes said second circuit breaker to open.

18. The system of claim 17, further comprising a feeder circuit having a third circuit breaker and a branch circuit having a fourth circuit breaker, said feeder circuit being downstream of said power bus, said branch circuit being downstream of said feeder circuit and said third circuit breaker, wherein downstream electrical parameters for said feeder circuit and said branch circuit are monitored by said control-processing unit, and wherein said control-processing unit selectively generates said trip command thereby opening said first circuit breaker based upon said downstream electrical parameters.

19. The system of claim 18, wherein said fourth circuit breaker is tripped only by said trip command.

20. The system of claim 18, wherein said feeder circuit is a plurality of feeder circuits having fifth circuit breakers, wherein one or more of said fifth circuit breakers are subjected to metering by said control-processing unit.
